(19) United States
(12) Patent Application Publication
(10) Pub. No.: US 2025/0262602 A1
(43) Pub. Date: Aug. 21, 2025

(54) SYSTEM FOR PRODUCING A MIXTURE OF FLUIDS IN A MICROFLUIDIC CHANNEL AND ASSOCIATED METHOD NOTABLY FOR FORMULATING LIPOSOME-BASED MEDICAMENTS THROUGH THE ALTERNATING INJECTION OF TWO LIQUID PHASES

(71) Applicant: INSIDE THERAPEUTICS, ANGOULÊME (FR)

(72) Inventors: Audrey NSAMELA, ORSAY (FR); Thomas GUERINIER, ANGOULÊME (FR); Guilhem VELVE CASQUILLAS, PARIS (FR)

(21) Appl. No.: 18/857,444

(22) PCT Filed: Apr. 6, 2023
(86) PCT No.: PCT/EP2023/059114

§ 371 Date: Oct. 16, 2024

(30) Foreign Application Priority Data
Apr. 20, 2022 (FR) FR2203631

(51) Int. Cl. B01F 33/30; B01F 35/221

(52) U.S. Cl. CPC B01F 33/305; B01F 35/2213; B01F 2215/0431; B01F 2215/0454; B01F 2215/0468

(57) ABSTRACT

A system to produce a mixture of fluids includes a pressure source, a pressure regulator, at least a first container containing a first fluid and a second container containing a second fluid, and a microfluidic mixer. A control unit is configured to control the pressure level of the first fluid and the pressure level of the second fluid. The control unit is also configured to control an opening and closing of the first valve and of the second valve to inject the first fluid and second fluid successively into the microfluidic mixer, thereby generating a profile of fringes of the first fluid and of the second fluid within the common outlet channel.

The present invention relates to a system for producing a mixture of fluids in a microfluidic channel and an associated method in particular for the formulation of liposome-based drugs through alternating injection of two liquid phases.

Several systems for mixing organic solvent-lipid solution and aqueous solution in a microfluidic circuit have been described in the state-of-the-art literature. Existing methods most commonly involve passive mixers, such as hydrodynamic focusing or chaotic mixers, whose mixing performance is impacted by variations in the flow rates of the mixed phases. These limits scaling up for the production of liposomal drugs at large volumes. In addition, existing devices pose aggregation problems that may foul the microfluidic channels.

The objective of the invention is effectively remedying these drawbacks by proposing a system for producing a mixture of fluids comprising:
a source of pressure,
a pressure regulator to which said pressure source is connected,
at least a first container containing a first fluid and a second container containing a second fluid, a pressurization of the first fluid and the second fluid being controlled by the pressure regulator,
a microfluidic mixer comprising at least a first inlet orifice and a second inlet orifice associated with at least a first valve and a second valve,
the first container being connected to the first inlet orifice via the first valve and the second container being connected to the second inlet orifice via the second valve,
said microfluidic mixer further comprising at least a first microfluidic conduit and a second microfluidic conduit, the first microfluidic inlet conduit being in fluid communication with the first inlet orifice and the second microfluidic inlet conduit being in fluid communication with the second inlet orifice, said first microfluidic inlet conduit and said second microfluidic inlet conduit intersecting with a non-zero angle at an intersection opening into at least one common outlet channel, and
a control unit for controlling a pressure level of the first fluid inside the first container and a pressure level of the second fluid inside the second container as well as an opening and closing of the first valve and the second valve in order to carry out successive injections of the first fluid and the second fluid into the microfluidic mixer so as to generate a fringe profile of the first fluid and the second fluid inside the common outlet channel.

The invention thus makes it possible to produce a rapid and homogeneous mixture which is necessary for the formulation of small-sized nanoparticles, in particular smaller than 100 nm. Due to the absence of a static liquid-liquid interface as well as ultra-rapid pressure variations, the invention drastically reduces the aggregation of nanoparticles and the accumulation thereof in the microfluidic channel. Avoiding fouling of the microfluidic circuit also reduces the formation of fluidic instabilities. In addition, the invention makes it possible to reduce the dilution time of an organic-lipid phase in an aqueous phase to less than 1 ms thanks to the alternating and optimized generation of organic-lipid and aqueous fringes in a pulsed manner, allowing thereby the formulation of liposomes with high size mono-disparities. Preferably, the polydispersity index PD1 is less than 0.1.

According to one embodiment of the invention, the control unit is configured to generate a fringe profile comprising an alternation of fringes of the first fluid and fringes of the second fluid.

According to one embodiment of the invention, the control unit is configured such that the fringes of the first fluid are narrower than the fringes of the second fluid.

According to one embodiment of the invention, a ratio formed by a volume of a fringe of the second fluid divided by a volume of a fringe of the first fluid is between 2 and 20, in particular between 8 and 15 and preferably between 9 and 11.

According to one embodiment of the invention, the first container contains a solution of lipids and/or polymers diluted in an organic solvent corresponding to the first fluid and the second container contains an aqueous solution corresponding to the second fluid.

According to one embodiment of the invention, the first valve and the second valve are solenoid valves with a low dead volume, in particular less than 5 μL, and high responsiveness, in particular less than 5 ms.

According to one embodiment of the invention, the common outlet channel is extended by a channel having a cross-section width greater than that of the common outlet channel.

According to one embodiment of the invention, said system comprises an interchangeable flow rate sensor for measuring a fluid flow rate at the outlet of the microfluidic mixer.

According to one embodiment of the invention, the first microfluidic inlet conduit and the second microfluidic inlet conduit intersect with an angle equal to or less than 90 degrees.

According to one embodiment of the invention, the first microfluidic inlet conduit and the second microfluidic inlet conduit each have a cross-sectional height between 150 μm and 300 μm and preferably of the order of 200 μm and a width between 150 μm and 300 μm and preferably of the order of 200 μm.

According to one embodiment of the invention, the pressure level of the first fluid inside the first container and the pressure level of the second fluid inside the second container are each between 0 and 8000 mbar.

According to one implementation of the invention, an injection frequency equal to the inverse of the sum of an injection duration of the first fluid and an injection duration of the second fluid is between 0.1 Hz and 200 Hz and is preferably between 10 Hz and 100 Hz.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

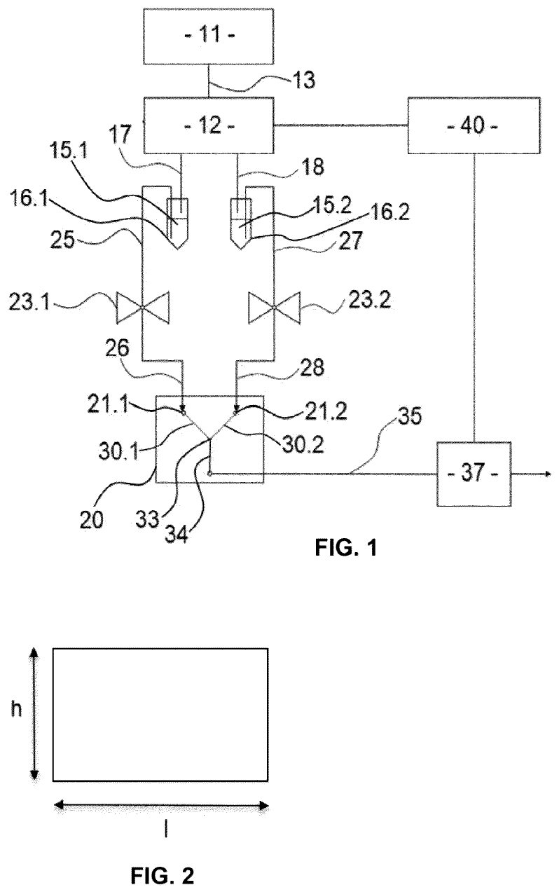

FIG. 1 is a schematic representation of a system for producing a mixture of two fluids according to the present invention.

FIG. 2 is a cross-sectional view of a microfluidic conduit used in the system according to the present invention.

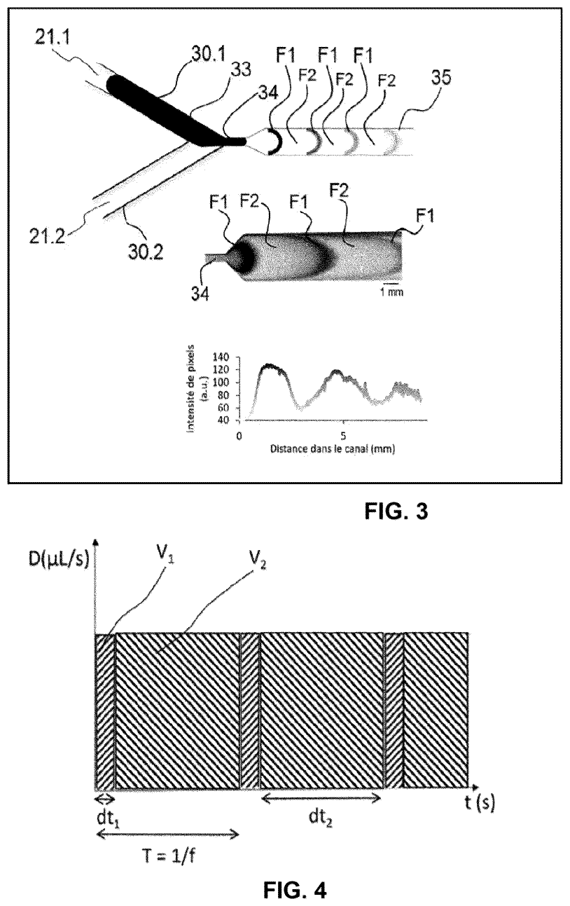

FIG. 3 illustrates the method of generating alternating fringes in the static microfluidic mixer according to the present invention.

FIG. 4 shows, during an injection phase of alternating fringes of the first fluid and the second fluid, a representation as a function of time of a flow rate of the first fluid and the second fluid.

It should be noted that structural and/or functional elements common to the different embodiments have the same references. Thus, unless otherwise stated, such elements have identical structural, dimensional and material properties.

FIG. 1 shows a system 10 for producing fluid mixtures comprising a pressure source 11 which may for example take the form of an air compressor or a bottle containing a pressurized gas, such as air or nitrogen.

The pressure source 11 is connected, via a conduit 13, to a pressure regulator 12 for controlling a pressurization of a first fluid 15.1 and a second fluid 15.2 contained respectively inside a first container 16.1 and a second container 16.2. The pressure regulator 12 is connected to the first container 16.1 via the conduit 17. The pressure regulator 12 is connected to the second container 16.2 via the conduit 18. The pressure regulator 12 may be a regulator of the PID (Proportional, Derivative, Integral) type based on the use of highly sensitive piezoelectric sensors.

Advantageously, the first container 16.1 contains a solution of lipids and/or polymers diluted in an organic solvent corresponding to the first fluid 15.1 (organic phase). The second container 16.2 contains an aqueous solution corresponding to the second fluid 15.2 (aqueous phase).

A microfluidic mixer 20 comprises a first inlet orifice 21.1 to which the first container 16.1 is connected via a first valve 23.1 and a second inlet orifice 21.2 to which the second container 16.2 is connected via a second valve 23.2. The first valve 23.1 and the second valve 23.2 are preferably solenoid valves (also called electromagnetic valves) with a low dead volume, in particular less than 5 μL, and high responsiveness, in particular less than 5 ms.

For this purpose, the first container 16.1 is in fluid communication with the inlet of the first valve 23.1 via the conduit 25. The outlet of the first valve 23.1 is in fluid communication with the first inlet orifice 21.1 via the conduit 26. The second container 16.2 is in fluid communication with the inlet of the second valve 23.2 via the conduit 27. The outlet of the second valve 23.2 is in fluid communication with the first inlet orifice 21.1 via the conduit 28.

The static microfluidic mixer 20 further comprises a first microfluidic inlet conduit 30.1 in fluid communication with the first inlet orifice 21.1 and a second microfluidic inlet conduit 30.2 in fluid communication with the second inlet orifice 21.2. As illustrated in FIG. 2, the first microfluidic inlet conduit 30.1 and the second microfluidic inlet conduit 30.2 each have a cross section height h between 150 μm and 300 μm and preferably of the order of 200 μm and a width l between 150 μm and 300 μm and preferably of the order of 200 μm. By “of the order of” it is meant a variation of plus or minus 10% relative to the indicated value.

The first microfluidic inlet conduit 30.1 and the second microfluidic inlet conduit 30.2 intersect with a non-zero angle relative at an intersection 33 opening into a common outlet channel 34. Advantageously, the first microfluidic inlet conduit 30.1 and the second microfluidic inlet conduit 30.2 intersect, i.e. they cut each other, with an angle equal to or less than 90 degrees. The outlet orifices of the first conduit 30.1 and the second conduit 30.2 open at the intersection 33.

The common outlet channel 34 is extended by a channel 35 having a cross-sectional width greater than that of the common outlet channel 34. According to an exemplary embodiment, the common outlet channel 34 may have a width l approximately equal to twice the width l of a microfluidic inlet conduit 30.1, 30.2, i.e. a width l of the order of 400 μm. The common outlet channel 34 is extended by another channel 35 having a cross-sectional width l between 1 and 5 mm and preferably of the order of 3 mm. The heights h of the conduits 30.1, 30.2, 34, 35 may be identical to each other. Alternatively, the heights h may vary from one conduit 30.1, 30.2, 34, 35 to another. The heights h may also be variable within the same microfluidic conduit/channel 30.1, 30.2, 34, 35.

An interchangeable 37 flow rate sensor is provided for flow rate measurement of fluid at the outlet of the microfluidic mixer 20.

A control unit 40 is capable of controlling a pressure level of the first fluid 15.1 inside the first container 16.1 and a pressure level of the second fluid 15.2 inside the second container 16.2 as well as an opening and closing of the first valve 23.1 and the second valve 23.2 to carry out successive injections of the first fluid 15.1 and the second fluid 15.2 inside the microfluidic mixer 20, so as to generate a fringe profile F1, F2 of the first fluid 15.1, and of the second fluid 15.2 inside the common outlet channel 34. The pressure levels of the first fluid 15.1 and of the second fluid 15.2 are controlled by the control unit 40 via the pressure regulator 12. The control unit 40 is electrically connected to the valves 23.1, 23.2 to control the opening and closing thereof.

FIG. 3 illustrates the method of generating alternating fringes F1, F2 in the common outlet channel 34 of the microfluidic mixer 20 and an experimental model produced with a fluorophore diluted in ethanol (corresponding to the first fluid 15.1) and water (corresponding to the second fluid 15.2). In the figure, the fluorophore diluted in ethanol appears darker than water. The mixing system 10 multiplies the liquid-liquid interfaces between the organic phase and the aqueous phase, which promotes mixing between the two fluids.

It is observed that the control unit 40 is configured to generate a fringe profile F1, F2 comprising an alternation of fringes F1, F2 of the first fluid 15.1 and fringes F1, F2 of the second fluid 15.2, that is to say that a fringe F1 of the first fluid 15.1 (fluophore+ethanol) is followed by a fringe F2 of the second fluid 15.2 (water) which is itself followed by a fringe F1 of the first fluid 15.1 and so on. A fringe F1, F2 corresponds to the quantity of fluid through a valve 23.1, 23.2 during an opening time thereof. Adapting the opening time of a valve 23.1, 23.2 and the pressure level of the corresponding fluid makes it possible to adapt the width of the fringes F1, F2.

Advantageously, the control unit 40 is configured such that the fringes F1 of the first fluid 15.1 are narrower than the fringes F2 of the second fluid 15.2 in order to promote the dilution of the first fluid 15.1 in the second fluid 15.2.

FIG. 4 shows, during a phase of injection of alternating fringes of the first fluid and the second fluid, a representation as a function of time (in seconds) of a flow rate D of the first fluid and the second fluid expressed in microliter/s. Preferably, a ratio formed by a volume V2 of a fringe F2 of the second fluid divided by a volume V1 of a fringe F1 of the first fluid 15.1 is between 2 and 20, in particular between 8 and 15 and preferably between 9 and 11.

An injection frequency f equal to the inverse of the sum of an injection duration dt1 of the first fluid and an injection duration dt2 of the second fluid is between 0.1 and 200 Hz and is preferably between 10 Hz and 100 Hz.

The injection duration dt1 of the first fluid and the injection duration dt2 of the second fluid correspond respectively to the opening duration of the first valve 23.1 and to the opening duration of the second valve 23.2. For equal injection flow rates of the first fluid and the second fluid, the ratio dt2/dt1 is equal to the ratio V2/V1.

The pressure level of the first fluid 15.1 inside the first container 16.1 and the pressure level of the second fluid 15.2 inside the second container 16.2 are each between 0 and 8000 mbar, in particular between 500 mbar and 7500 mbar.

As can be seen in FIG. 3, the intensity of the fringes F1 decreases rapidly with distance from the outlet of the channel 34. The graph indicating a pixel intensity level as a function of distance from the outlet of the channel 34 shows that the organic phase dilutes after passing through a little more than 5 mm in the channel 35.

The invention makes it possible to reduce the dilution time of an organic phase of lipids (and/or polymers) in an aqueous phase to less than 1 ms. The invention further allows a formulation of liposomes with high size mono-disparities (PDI<0.1). The invention also makes it possible to optimize the nucleation speed of lipid nanoparticles.

These data (fluid pressure level, fluid injection frequency and corresponding duty cycles) are provided as input parameters to the control unit 40. For this purpose, a human-machine interface may be used, such as a keyboard, a touch screen, or any other device adapted to the application.

The control unit 40 may include a memory for storing software instructions for controlling the pressure regulator 12 and the valves according to the input parameters received. The control unit 40 may for example take the form of a computer or a microcontroller dedicated to the application.

This precise control of the duration and amplitude of the pulsed injections determines the profile of the fringes F1, F2 of organic solvent-lipid and/or polymer solution and of aqueous solution, and consequently, the final size of the liposomes.

The invention also relates to the method for producing a mixture of fluids implemented by the system 10.

Alternatively, the system 10 is devoid of the conduit 35 and comprises the conduit 34 only.

Alternatively, the system 10 is used to produce a gas mixture.

Alternatively, the microfluidic mixer 20 may comprise more than two inlet orifices 21.1, 21.2, in particular N inlet orifices associated with N microfluidic conduits and N valves (N being an integer). The fringe profile inside the common outlet channel 34 can then be a combination of N fluids injected one after the other or according to any possible combination type for the fluids present. The number of containers can also be greater than two.

Alternatively, it is possible to use multiple common output channels each corresponding to a specific fringe profile.

Alternatively, it is also possible to use 3/2 distributors, rotary valves, or any other means of alternately injecting fluids into a common outlet channel.

Of course, the different characteristics, variants and/or embodiments of the present invention can be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1-12. (canceled)

13. A system to produce a mixture of fluids, comprising:
a pressure source;
a pressure regulator to which said pressure source is connected thereto;
at least a first container containing a first fluid and a second container containing a second fluid, a pressurization of the first fluid and the second fluid being controlled by the pressure regulator;
a microfluidic mixer comprising at least a first inlet orifice and a second inlet orifice associated with at least a first valve and a second valve;
the first container being connected to the first inlet orifice via the first valve and the second container being connected to the second inlet orifice via the second valve;
the microfluidic mixer further comprising at least a first microfluidic conduit and a second microfluidic conduit, the first microfluidic inlet conduit being in fluid communication with the first inlet orifice and the second microfluidic inlet conduit being in fluid communication with the second inlet orifice, said first microfluidic inlet conduit and said second microfluidic inlet conduit intersecting with a non-zero angle at an intersection opening into at least one common outlet channel; and
a control unit to control a pressure level of the first fluid inside the first container, a pressure level of the second fluid inside the second container, an opening and closing of the first valve and of the second valve to perform successive injections of the first fluid and of the second fluid inside the microfluidic mixer, thereby generating a fringe profile of the first fluid and the second fluid inside said at least one common outlet channel.

14. The system of claim 13, wherein the control unit is configured to generate the fringe profile comprising an alternation of fringes of the first fluid and fringes of the second fluid.

15. The system of claim 14, wherein the fringes of the first fluid are narrower than the fringes of the second fluid.

16. The system of claim 15, wherein a ratio formed by a volume of a fringe of the second fluid divided by a volume of a fringe of the first fluid is between 2 and 20.

17. The system of claim 15, wherein a ratio formed by a volume of a fringe of the second fluid divided by a volume of a fringe of the first fluid is between 8 and 15.

18. The system of claim 15, wherein a ratio formed by a volume of a fringe of the second fluid divided by a volume of a fringe of the first fluid is between 9 and 11.

19. The system of claim 13, wherein the first container contains a solution of at least one of lipids and polymers diluted in an organic solvent corresponding to the first fluid and wherein the second container contains an aqueous solution corresponding to the second fluid.

20. The system of claim 13, wherein the first valve and the second valve are solenoid valves with a low dead volume less than 5 μL, and a high responsiveness less than 5 ms.

21. The system of claim 13, wherein said at least one common outlet channel is extended by a channel having a cross-section width greater than that of said at least one common outlet channel.

22. The system of claim 13, further comprising an interchangeable flow rate sensor to measure a fluid flow rate at an outlet of the microfluidic mixer.

23. The system of claim 13, wherein the first microfluidic inlet conduit and the second microfluidic inlet conduit intersect with an angle equal to or less than 90 degrees.

24. The system of claim 13, wherein each of the first microfluidic inlet conduit and the second microfluidic inlet conduit comprises a cross-section height between 150 μm and 300 μm and a width between 150 μm and 300 μm.

25. The system of claim 13, wherein the pressure level of the first fluid inside the first container and the pressure level of the second fluid inside the second container are each between 0 and 8000 mbar.

26. The system of claim 13, wherein an injection frequency equal to an inverse of the sum of an injection duration of the first fluid and an injection duration of the second fluid is between 0.1 and 200 Hz.

27. The system of claim 13, wherein an injection frequency equal to an inverse of the sum of an injection duration of the first fluid and an injection duration of the second fluid is between 10 Hz and 100 Hz.
